(19) United States
(12) Patent Application Publication
(10) Pub. No.: US 2025/0103843 A1
(43) Pub. Date: Mar. 27, 2025

(54) TWO-DIMENSIONAL CODE ILLUSTRATION GENERATION SYSTEM

(71) Applicant: DENTSU INC., Tokyo (JP)

(72) Inventors: Yusuke KOYANAGI, Tokyo (JP); Shintaro MURAKAMI, Tokyo (JP)

(73) Assignee: DENTSU INC., Tokyo (JP)

(21) Appl. No.: 18/722,293

(22) PCT Filed: Oct. 28, 2022
(86) PCT No.: PCT/JP2022/040423

§ 371 Date: Dec. 13, 2024

(30) Foreign Application Priority Data
Dec. 28, 2021 (JP) 2021-213599

(51) Int. Cl. G06K 19/06; G06T 11/00

(52) U.S. Cl. CPC G06K 19/06037; G06T 11/001

(57) ABSTRACT

A two-dimensional code illustration generation system (1) generates a two-dimensional code (C) in which predetermined data is encoded, generates an illustration of both eyes of an animal character by giving a design identical to a first positioning symbol (P1) and a second positioning symbol (P2) and giving a design different to a third positioning symbol (P3), divides a code area (CA) into a face area (FA) including the first positioning symbol (P1) and the second positioning symbol (P2) and a body area (BA) including the third positioning symbol (P3), and adds a face part frame (F) around the face area (FA) or adds a body part frame (F) around the body area (BA) outside of the code area (CA).

### TECHNICAL FIELD

The present invention relates to a two-dimensional code illustration generation system that generates an illustration of an animal character using a two-dimensional code.

### BACKGROUND ART

In the related art, in order to encode various types of data, two-dimensional codes such as QR codes (registered trademark) have been used (see, for example, Patent Literature 1). In the related art, sheets having two-dimensional codes in which overviews of information encoded in the two-dimensional codes can be ascertained merely by viewing the two-dimensional codes have been proposed (for example, Patent Literature 2).

However, for sheets having two-dimensional codes of the related art, illustrations of animals or the like and two-dimensional codes are separately arranged, and the illustrations of the animals or the like and the two-dimensional codes are separately recognized. Systems that generate illustrations of animal characters integrated with two-dimensional codes (visually recognized two-dimensional codes integrally with illustrations of animal characters) have not appeared so far.

### CITATION LIST

### Patent Literature

Patent Literature 1: Japanese Patent No. 2867904
Patent Literature 2: JP 2007-304574 A

### SUMMARY OF INVENTION

### Technical Problem

The present invention has been devised under the foregoing circumstances. An object of the present invention is to provide a two-dimensional code illustration generation system capable of generating an illustration of an animal character integrated with a two-dimensional code (a visually recognized two-dimensional code integrated with an illustration of an animal character).

### Solution to Problem

According to an aspect of the present invention, a two-dimensional code illustration generation system generates an illustration of an animal character using a two-dimensional code. The two-dimensional code has a quadrangular code area having four corners. A positioning symbol is arranged at each of three corners among the four corners of the code area. The positioning symbol has a rectangular dark color pattern including a plurality of dark color cells arranged at a center part of the positioning symbol, a rectangular frame-shaped bright color pattern including a plurality of bright color cells arranged around the dark color pattern, and a rectangular frame-shaped dark color pattern including a plurality of dark color cells arranged around the bright color pattern. A data area where predetermined data is encoded using a plurality of bright color cells and a plurality of dark color cells is provided in a part inside the four corners of the code area. The two-dimensional code illustration generation system includes: an input unit to which the predetermined data is input; a two-dimensional code generation unit configured to generate the two-dimensional code in which the predetermined data is encoded in the data area based on the input predetermined data; a both-eye illustration generation unit configured to generate an illustration of both eyes of the animal character by replacing at least one of dark color cells included in the positioning symbol with a first deep color cell or replacing at least one of bright color cells included in the positioning symbol with a first light color cell for each of adjacent first and second positioning symbols among three positioning symbols included in the generated two-dimensional code, giving a design identical to the first positioning symbol and the second positioning symbol, further replacing at least one of dark color cells included in the positioning symbol with a second deep color cell having a color different from the first deep color cell or replacing at least one of bright color cells included in the positioning symbol with a second light color cell having a color different from the first light color cell for a remaining third positioning symbol among the three positioning symbols, and giving a design different from the first positioning symbol and the second positioning symbol to the third positioning symbol; a face-body division unit configured to divide the code area into a face area including the first positioning symbol and the second positioning symbol and a body area including the third positioning symbol; a frame addition unit configured to add a face part frame representing a part of a face of the animal character around the face area or add a body part frame representing a part of the body around the body area outside of the code area; and an output unit configured to generate an illustration of both eyes of the animal character, divide the illustration into the face area and the body area, and output the two-dimensional code to which the face part frame or the body part frame is added.

According to another aspect of the present invention, a method is executed in a two-dimensional code illustration generation system that generates an illustration of an animal character using a two-dimensional code. The two-dimensional code has a quadrangular code area having four corners. A positioning symbol is arranged at each of three corners among the four corners of the code area. The positioning symbol has a rectangular dark color pattern including a plurality of dark color cells arranged at a center part of the positioning symbol, a rectangular frame-shaped bright color pattern including a plurality of bright color cells arranged around the dark color pattern, and a rectangular frame-shaped dark color pattern including a plurality of dark color cells arranged around the bright color pattern. A data area where predetermined data is encoded using a plurality of bright color cells and a plurality of dark color cells is provided in a part inside the four corners of the code area. The method includes: a step of inputting the predetermined data; a step of generating the two-dimensional code in which the predetermined data is encoded in the data area based on the input predetermined data; a step of generating an illustration of both eyes of the animal character by replacing at least one of dark color cells included in the positioning symbol with a first deep color cell or replacing at least one of bright color cells included in the positioning symbol with a first light color cell for each of adjacent first and second positioning symbols among three positioning symbols included in the generated two-dimensional code, giving a design identical to the first positioning symbol and the second positioning symbol, further replacing at least one of dark color cells included in the positioning symbol with a second deep color cell having a color different from the first deep color cell or replacing at least one of bright color cells included in the positioning symbol with a second light color cell having a color different from the first light color cell for a remaining third positioning symbol among the three positioning symbols, and giving a design different from the first positioning symbol and the second positioning symbol to the third positioning symbol; a step of dividing the code area into a face area including the first positioning symbol and the second positioning symbol and a body area including the third positioning symbol; a step of adding a face part frame representing a part of a face of the animal character around the face area or adding a body part frame representing a part of the body around the body area outside of the code area; and a step of generating an illustration of both eyes of the animal character, divide the illustration into the face area and the body area, and outputting the two-dimensional code to which the face part frame or the body part frame is added.

According to still another aspect of the present invention, a program is executed by a computer of a two-dimensional code illustration generation system that generates an illustration of an animal character using a two-dimensional code. The two-dimensional code has a quadrangular code area having four corners. A positioning symbol is arranged at each of three corners among the four corners of the code area. The positioning symbol has a rectangular dark color pattern including a plurality of dark color cells arranged at a center part of the positioning symbol, a rectangular frame-shaped bright color pattern including a plurality of bright color cells arranged around the dark color pattern, and a rectangular frame-shaped dark color pattern including a plurality of dark color cells arranged around the bright color pattern. A data area where predetermined data is encoded using a plurality of bright color cells and a plurality of dark color cells is provided in a part inside the four corners of the code area. The program causes the computer to perform: a process of inputting the predetermined data; a process of generating the two-dimensional code in which the predetermined data is encoded in the data area based on the input predetermined data; a process of generating an illustration of both eyes of the animal character by replacing at least one of dark color cells included in the positioning symbol with a first deep color cell or replacing at least one of bright color cells included in the positioning symbol with a first light color cell for each of adjacent first and second positioning symbols among three positioning symbols included in the generated two-dimensional code, giving a design identical to the first positioning symbol and the second positioning symbol, further replacing at least one of dark color cells included in the positioning symbol with a second deep color cell having a color different from the first deep color cell or replacing at least one of bright color cells included in the positioning symbol with a second light color cell having a color different from the first light color cell for a remaining third positioning symbol among the three positioning symbols, and giving a design different from the first positioning symbol and the second positioning symbol to the third positioning symbol; a process of dividing the code area into a face area including the first positioning symbol and the second positioning symbol and a body area including the third positioning symbol; a process of adding a face part frame representing a part of a face of the animal character around the face area or adding a body part frame representing a part of the body around the body area outside of the code area; and a process of generating an illustration of both eyes of the animal character, divide the illustration into the face area and the body area, and outputting the two-dimensional code to which the face part frame or the body part frame is added.

As will be described below, the present invention has other aspects. Accordingly, the disclosure of this invention is intended to provide some aspects of the invention and is not intended to limit the scope of the invention described and claimed herein.

### BRIEF DESCRIPTION OF DRAWINGS

FIG. 1 is a block diagram illustrating a configuration of a two-dimensional code illustration generation system according to an embodiment of the present invention.

FIG. 2 is a diagram illustrating an example of a two-dimensional code according to the embodiment of the present invention.

FIG. 3 is a diagram illustrating an example of generation of a both-eye illustration according to the embodiment of the present invention.

FIG. 4 is a diagram illustrating an example of division of a face area and a body area according to the embodiment of the present invention.

FIG. 5 is a diagram illustrating an example of frame addition according to the embodiment of the present invention.

FIG. 6 is a diagram illustrating an example of face generation according to the embodiment of the present invention.

FIG. 7 is a diagram illustrating an example of nose generation according to the embodiment of the present invention.

FIG. 8 is a diagram illustrating an example of mouth generation according to the embodiment of the present invention.

FIG. 9 is a diagram illustrating an example of corner rounding-off according to the embodiment of the present invention.

FIG. 10 is a diagram illustrating an example of a two-dimensional code illustration generated according to the embodiment of the present invention.

FIG. 11 is a sequence diagram illustrating an operation of the two-dimensional code illustration generation system according to the embodiment of the present invention.

### DESCRIPTION OF EMBODIMENTS

Hereinafter, the present invention will be described in detail. Here, the following detailed description and the accompanying drawings do not limit the invention.

A two-dimensional code illustration generation system according to the present invention generates an illustration of an animal character using a two-dimensional code. The two-dimensional code has a quadrangular code area having four corners. A positioning symbol is arranged at each of three corners among the four corners of the code area. The positioning symbol has a rectangular dark color pattern including a plurality of dark color cells arranged at a center part of the positioning symbol, a rectangular frame-shaped bright color pattern including a plurality of bright color cells arranged around the dark color pattern, and a rectangular frame-shaped dark color pattern including a plurality of dark color cells arranged around the bright color pattern. A data area where predetermined data is encoded using a plurality of bright color cells and a plurality of dark color cells is provided in a part inside the four corners of the code area. The two-dimensional code illustration generation system includes: an input unit to which the predetermined data is input; a two-dimensional code generation unit configured to generate the two-dimensional code in which the predetermined data is encoded in the data area based on the input predetermined data; a both-eye illustration generation unit configured to generate an illustration of both eyes of the animal character by replacing at least one of dark color cells included in the positioning symbol with a first deep color cell or replacing at least one of bright color cells included in the positioning symbol with a first light color cell for each of adjacent first and second positioning symbols among three positioning symbols included in the generated two-dimensional code, giving a design identical to the first positioning symbol and the second positioning symbol, further replacing at least one of dark color cells included in the positioning symbol with a second deep color cell having a color different from the first deep color cell or replacing at least one of bright color cells included in the positioning symbol with a second light color cell having a color different from the first light color cell for a remaining third positioning symbol among the three positioning symbols, and giving a design different from the first positioning symbol and the second positioning symbol to the third positioning symbol; a face-body division unit configured to divide the code area into a face area including the first positioning symbol and the second positioning symbol and a body area including the third positioning symbol; a frame addition unit configured to add a face part frame representing a part of a face of the animal character around the face area or add a body part frame representing a part of the body around the body area outside of the code area; and an output unit configured to generate an illustration of both eyes of the animal character, divide the illustration into the face area and the body area, and output the two-dimensional code to which the face part frame or the body part frame is added.

Accordingly, the illustration of both eyes of the animal character is generated using the positioning symbol of the two-dimensional code, the two-dimensional code is further divided into the face area and the body area, and the face part frame is added to the face area or the body part frame is added to the body area. Therefore, the illustration of the animal character integrated with the two-dimensional code (a visually recognized two-dimensional code integrated with an illustration of an animal character) can be generated. In this case, the dark color cell included in the two-dimensional code is replaced with the deep color cell (the first deep color cell or the second deep color cell), and the bright color cell included in the two-dimensional code is replaced with the light color cell (the first light color cell or the second light color cell). Therefore, data encoded into the two-dimensional code can be read even from the generated illustration.

In the two-dimensional code illustration generation system according to the present invention, the face-body division unit may divide the code area into a face area including the first positioning symbol and the second positioning symbol, a body area including the third positioning symbol, and a boundary area between the face area and the body area, and replace a bright color cell included in the boundary area with a predetermined background color cell.

Accordingly, the bright color cell included in the boundary area between the face area and the body area is replaced with the background color cell. Therefore, the face area and the body area can be visually recognized separately in the illustration of the animal character integrated with the two-dimensional code.

The two-dimensional code illustration generation system according to the present invention may further include: a face generation unit configured to replace, in the face area, at least one of a plurality of dark color cells included in the data area with a third deep color cell having a color different from the first deep color cell and the second deep color cell, or replace at least one of a plurality of bright color cells included in the data area with a third light color cell having a color different from the first light color cell and the second light color cell; and a nose generation unit configured to replace, in the face area, one dark color cell or a plurality of dark color cells included in a nose area set between the first positioning symbol and the second positioning symbol in a horizontal direction and below the first positioning symbol and the second positioning symbol in a vertical direction with a fourth deep color cell having a different color from the first deep color cell, the second deep color cell, and the third deep color cell.

Accordingly, in the face area, the nose area is set between both eyes (the first positioning symbol and the second positioning symbol) in the horizontal direction and below both eyes (the first positioning symbol and the second positioning symbol) in the vertical direction, and the dark color cell included in the nose area is replaced with a deep color cell (fourth deep color cell) having a color different from the other deep color cells (first to third deep color cells). Therefore, the face area (both eyes and the nose) can be visually recognized in the illustration of the animal character integrated with the two-dimensional code.

The two-dimensional code illustration generation system according to the present invention may include: a face generation unit configured to replace, in the face area, at least one of a plurality of dark color cells included in the data area with a third deep color cell having a color different from the first deep color cell and the second deep color cell, or replace at least one of a plurality of bright color cells included in the data area with a third light color cell having a color different from the first light color cell and the second light color cell; and a mouth generation unit configured to replace, in the face area, one dark color cell or a plurality of dark color cells included in a mouth area set further below a nose area set below the first positioning symbol and the second positioning symbol in a vertical direction with a fourth deep color cell having a color different from the first deep color cell, the second deep color cell, and the third deep color cell.

Accordingly, in the face area, the mouth area is set between both eyes (the first positioning symbol and the second positioning symbol) in the horizontal direction and further below the nose area set below both eyes (the first positioning symbol and the second positioning symbol) in the vertical direction, and the dark color cell included in the mouth area is replaced with a deep color cell (fourth deep color cell) having a color different from the other deep color cells (the first to third deep color cells). Therefore, the face area (both eyes and the mouth) can be visually recognized in the illustration of the animal character integrated with the two-dimensional code.

The two-dimensional code illustration generation system according to the present invention may include a corner rounding-off unit configured to replace cells arranged at four vertexes of the code area with a predetermined background color cell.

Accordingly, the cells arranged at the four vertexes of the code area of the two-dimensional code are replaced with the background color cell. Therefore, the contour of the illustration of the animal character integrated with the two-dimensional code can be rounded.

The two-dimensional code illustration generation system according to the present invention may be configured such that the predetermined data includes a shortened URL of which an amount of data is less than an amount of data of a regular URL and a hash value corresponding to the regular URL, and the regular URL is acquirable by using the shortened URL and the hash value.

Accordingly, the amount of data encoded in the data area can be reduced by using the shortened URL of which an amount of data is less than an amount of data of the regular URL (notation of the URL is short).

When the shortened URL is not used, the amount of data of the regular URL is large (the notation of the URL is long), and the amount of data encoded in the data area is large, a proportion (area proportion) of the data area to the code area increases, and the size of the positioning symbol relatively decreases. As a result, the size of both eyes of the animal character becomes small and the interval becomes wide, and it becomes difficult to recognize the animal character, or it becomes difficult to express the animal character cutely.

Even when the amount of data of the regular URL is large, the amount of data encoded in the data area can be reduced by using the shortened URL, and the size of the positioning symbol can be maintained. As a result, the size of the both eyes of the animal character can be maintained at an appropriate size and an interval between the both eyes can be maintained at an appropriate distance, and the animal character can be easily recognized, or the animal character can be expressed cutely.

The two-dimensional code illustration generation system according to the present invention may include a whitelist storage unit configured to store data allowed to be encoded in the data area as whitelist information in advance. When the input predetermined data is included in the whitelist information, the two-dimensional code generation unit may generate the two-dimensional code in which the predetermined data is encoded in the data area.

Accordingly, when the input data (for example, a URL of a store or the like) is included in the whitelist information, the two-dimensional code is appropriately generated. The whitelist information (for example, a URL of a specific service member store, or the like) can be managed by, for example, a system operator.

The two-dimensional code illustration generation system according to the present invention may include a blacklist storage unit configured to store data prohibited from being encoded in the data area as blacklist information in advance. When the input predetermined data is included in the blacklist information, the two-dimensional code generation unit may not generate the two-dimensional code in which the predetermined data is encoded in the data area.

Accordingly, when the input data (for example, a URL of a store or the like) is included in the blacklist information, the two-dimensional code is prohibited from being generated. The blacklist information (for example, a URL of harmful site) can be managed by, for example, a system operator.

A method according to the present invention is executed in a two-dimensional code illustration generation system that generates an illustration of an animal character using a two-dimensional code. The two-dimensional code has a quadrangular code area having four corners. A positioning symbol is arranged at each of three corners among the four corners of the code area. The positioning symbol has a rectangular dark color pattern including a plurality of dark color cells arranged at a center part of the positioning symbol, a rectangular frame-shaped bright color pattern including a plurality of bright color cells arranged around the dark color pattern, and a rectangular frame-shaped dark color pattern including a plurality of dark color cells arranged around the bright color pattern. A data area where predetermined data is encoded using a plurality of bright color cells and a plurality of dark color cells is provided in a part inside the four corners of the code area. The method includes: a step of inputting the predetermined data; a step of generating the two-dimensional code in which the predetermined data is encoded in the data area based on the input predetermined data; a step of generating an illustration of both eyes of the animal character by replacing at least one of dark color cells included in the positioning symbol with a first deep color cell or replacing at least one of bright color cells included in the positioning symbol with a first light color cell for each of adjacent first and second positioning symbols among three positioning symbols included in the generated two-dimensional code, giving a design identical to the first positioning symbol and the second positioning symbol, further replacing at least one of dark color cells included in the positioning symbol with a second deep color cell having a color different from the first deep color cell or replacing at least one of bright color cells included in the positioning symbol with a second light color cell having a color different from the first light color cell for a remaining third positioning symbol among the three positioning symbols, and giving a design different from the first positioning symbol and the second positioning symbol to the third positioning symbol; a step of dividing the code area into a face area including the first positioning symbol and the second positioning symbol and a body area including the third positioning symbol; a step of adding a face part frame representing a part of a face of the animal character around the face area or adding a body part frame representing a part of the body around the body area outside of the code area; and a step of generating an illustration of both eyes of the animal character, dividing the illustration into the face area and the body area, and outputting the two-dimensional code to which the face part frame or the body part frame is added.

According to this method, similarly to the foregoing system, the illustration of both eyes of the animal character is generated using the positioning symbol of the two-dimensional code, and the two-dimensional code is further divided into the face area and the body area, and the face part frame is added to the face area or the body part frame is added to the body area. Therefore, it is possible to generate the illustration of the animal character integrated with the two-dimensional code (a visually recognized two-dimensional code integrated with the illustration of the animal character). In this case, the dark color cell included in the two-dimensional code is replaced with the deep color cell (the first deep color cell or the second deep color cell), and the bright color cell included in the two-dimensional code is replaced with the light color cell (the first light color cell or the second light color cell). Therefore, data encoded into the two-dimensional code can be read even from the generated illustration.

A program according to the present invention is executed by a computer of a two-dimensional code illustration generation system that generates an illustration of an animal character using a two-dimensional code. The two-dimensional code has a quadrangular code area having four corners. A positioning symbol is arranged at each of three corners among the four corners of the code area. The positioning symbol has a rectangular dark color pattern including a plurality of dark color cells arranged at a center part of the positioning symbol, a rectangular frame-shaped bright color pattern including a plurality of bright color cells arranged around the dark color pattern, and a rectangular frame-shaped dark color pattern including a plurality of dark color cells arranged around the bright color pattern. A data area where predetermined data is encoded using a plurality of bright color cells and a plurality of dark color cells is provided in a part inside the four corners of the code area. The program causes the computer to perform: a process of inputting the predetermined data; a process of generating the two-dimensional code in which the predetermined data is encoded in the data area based on the input predetermined data; a process of generating an illustration of both eyes of the animal character by replacing at least one of dark color cells included in the positioning symbol with a first deep color cell or replacing at least one of bright color cells included in the positioning symbol with a first light color cell for each of adjacent first and second positioning symbols among three positioning symbols included in the generated two-dimensional code, giving a design identical to the first positioning symbol and the second positioning symbol, further replacing at least one of dark color cells included in the positioning symbol with a second deep color cell having a color different from the first deep color cell or replacing at least one of bright color cells included in the positioning symbol with a second light color cell having a color different from the first light color cell for a remaining third positioning symbol among the three positioning symbols, and giving a design different from the first positioning symbol and the second positioning symbol to the third positioning symbol; a process of dividing the code area into a face area including the first positioning symbol and the second positioning symbol and a body area including the third positioning symbol; a process of adding a face part frame representing a part of a face of the animal character around the face area or adding a body part frame representing a part of the body around the body area outside of the code area; and a process of generating an illustration of both eyes of the animal character, dividing the illustration into the face area and the body area, and outputting the two-dimensional code to which the face part frame or the body part frame is added.

According to this program, similarly to the foregoing system, the illustration of both eyes of the animal character are generated using the positioning symbol of the two-dimensional code, and the two-dimensional code is further divided into the face area and the body area, and the face part frame is added to the face area or the body part frame is added to the body area. Therefore, it is possible to generate the illustration of the animal character integrated with the two-dimensional code (the visually recognized two-dimensional code integrated with the illustration of the animal character). In this case, the dark color cell included in the two-dimensional code is replaced with the deep color cell (the first deep color cell or the second deep color cell), and the bright color cell included in the two-dimensional code is replaced with the light color cell (the first light color cell or the second light color cell). Therefore, data encoded into the two-dimensional code can be read even from the generated illustration.

According to the present invention, an illustration of an animal character integrated with a two-dimensional code (a visually recognized two-dimensional code integrated with an illustration of an animal character) can be generated, and data encoded into a two-dimensional code can be read even from the generated illustration.

### EMBODIMENT

Hereinafter, a two-dimensional code illustration generation system according to an embodiment of the present invention will be described with reference to the drawings. In the present embodiment, a case of the two-dimensional code illustration generation system used for a system that generates an illustration of an animal character or the like using a two-dimensional code in which a URL of a store, a commercial facility, or the like is encoded will be exemplified.

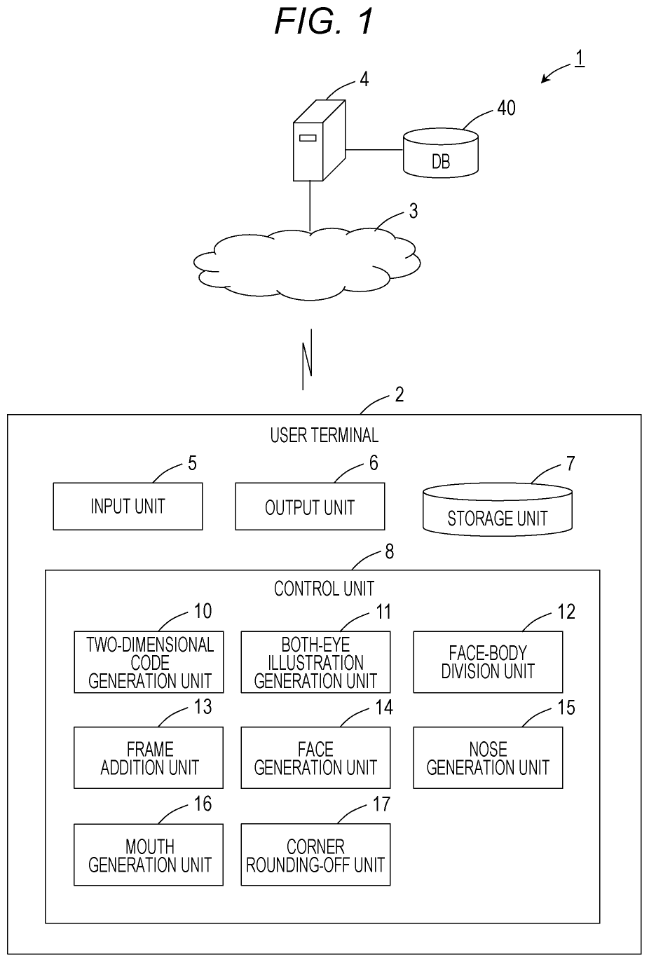

A configuration of the two-dimensional code illustration generation system according to an embodiment of the present invention will be described with reference to the drawings. FIG. 1 is a block diagram illustrating a configuration of a two-dimensional code illustration generation system according to the present embodiment. As illustrated in FIG. 1, a two-dimensional code illustration generation system 1 includes a user terminal 2 that is used by a user of the system, and a system server 4 that is connected to the user terminal 2 via a network 3. The user terminal 2 is configured as, for example, a smartphone or a personal computer. The system server 4 includes, for example, a cloud server and includes a cloud database 40.

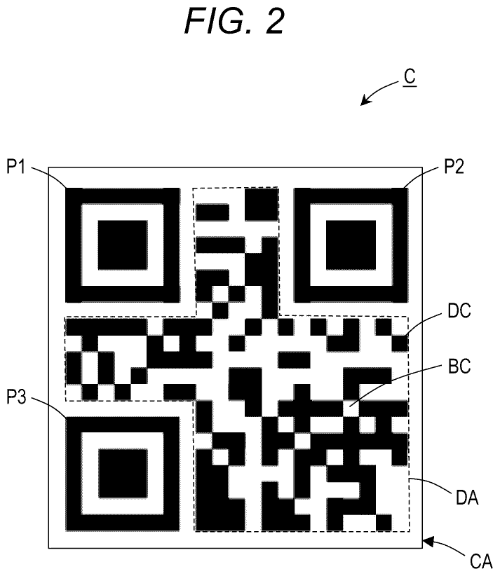

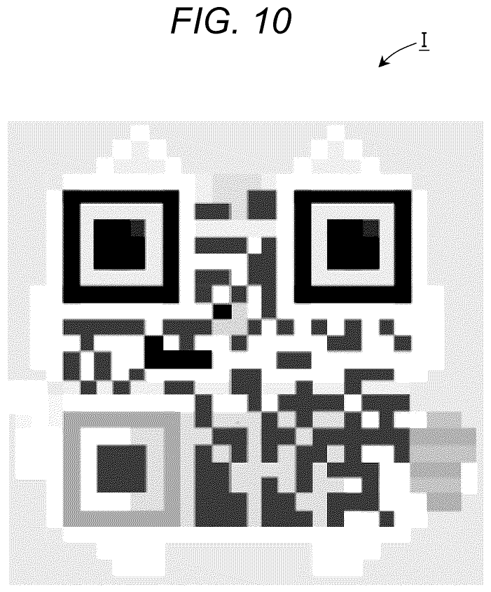

As illustrated in FIG. 1, the user terminal 2 includes an input unit 5, an output unit 6, a storage unit 7, and a control unit 8. The input unit 5 is an input interface that receives an input from a user. Data such as a URL of a store, a commercial facility, or the like is input to the input unit 5. The output unit 6 is an output interface (for example, a display screen) that performs an output to the user. A two-dimensional code illustration I (see FIG. 10) generated using a two-dimensional code C (see FIG. 2) is output (for example, displayed on the screen) from the output unit 6. The storage unit 7 is configured as, for example, a storage medium such as a memory. The storage unit 7 stores various types of data and various programs used to generate the two-dimensional code illustration I. The control unit 8 is configured as, for example, a CPU and has various functions of generating the two-dimensional code illustration I. The functions of the control unit 8 are realized by executing programs stored in the storage unit 7. The program can be implemented as, for example, a web application downloaded from the system server 4 each time. The system server 4 may have each function of the control unit 8 of the user terminal 2.

As illustrated in FIG. 1, the control unit 8 includes a two-dimensional code generation unit 10, a both-eye illustration generation unit 11, a face-body division unit 12, a frame addition unit 13, a face generation unit 14, a nose generation unit 15, a mouth generation unit 16, and a corner rounding-off unit 17 as functional blocks that generate the two-dimensional code illustration I.

The two-dimensional code generation unit 10 has a function of generating the two-dimensional code C in which predetermined data is encoded in the data area DA based on predetermined data (for example, a URL of a store, a commercial facility, or the like) input by the user. A known technique can be used to generate the two-dimensional code C.

FIG. 2 is a diagram illustrating an example of the two-dimensional code C. As illustrated in FIG. 2, the two-dimensional code C is, for example, a QR code (registered trademark). The two-dimensional code C has a rectangular code area CA having four corners, and positioning symbols P1 to P3 are arranged at three corners of the four corners of the code area CA. The positioning symbols P1 to P3 have a rectangular dark color pattern including a plurality of dark color cells DC arranged at the center parts of the positioning symbols P1 to P3, a rectangular frame-shaped bright color pattern including a plurality of bright color cells BC arranged around the dark color pattern, and a rectangular frame-shaped dark color pattern including a plurality of dark color cells DC arranged around the bright color pattern. The data area DA in which predetermined data is encoded using the plurality of bright color cells BC and the plurality of dark color cells DC is provided in a part inside the four corners of the code area CA.

The predetermined data encoded in the data area DA of the two-dimensional code C may include a shortened URL having a smaller amount of data than the regular URL (for example, a URL of a store, a commercial facility, or the like) and a hash value corresponding to the regular URL and may be configured to acquire the regular URL by using the shortened URL and the hash value. A known technique can be used to generate the shortened URL and the hash value.

Data allowed to be encoded in the data area DA is stored in advance in the system server 4 (cloud database 40) as the whitelist information. The two-dimensional code generation unit 10 may acquire the whitelist information from the system server 4 (cloud database 40) and generate the two-dimensional code C in which predetermined data is encoded in the data area DA when the input predetermined data is included in the whitelist information. The whitelist information may be stored in the storage unit 7 of the user terminal 2.

Data prohibited from being encoded in the data area DA is stored in advance in the system server 4 (cloud database 40) as blacklist information. The two-dimensional code generation unit 10 may acquire the blacklist information from the system server 4 (cloud database 40), and may not generate the two-dimensional code C in which the predetermined data is encoded in the data area DA when the input predetermined data is included in the blacklist information. The blacklist information may be stored in the storage unit 7 of the user terminal 2.

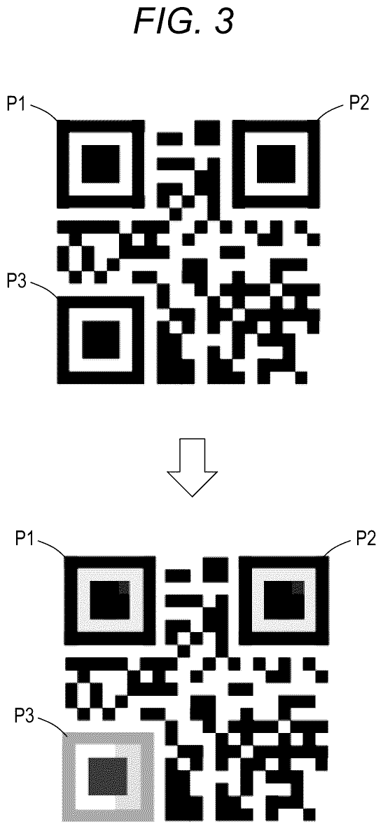

The both-eye illustration generation unit has a function of generating an illustration of both eyes of an animal character using the positioning symbols P1 to P3. Specifically, as illustrated in FIG. 3, for each of the adjacent first positioning symbol P1 and second positioning symbol P2 among the three positioning symbols P1 to P3 included in the generated two-dimensional code C, the both-eye illustration generation unit replaces at least one of dark color cells DC included in the positioning symbols P1 and P2 with the first deep color cell, or replaces at least one of the bright color cells BC included in the positioning symbols P1 and P2 with the first light color cell, and gives the design identical to the first positioning symbol P1 and the second positioning symbol P2. Further, for the remaining third positioning symbol P3 among the three positioning symbols P1 to P3, the both-eye illustration generation unit replaces at least one of the dark color cells DC included in the positioning symbol P3 with the second deep color cell having a color different from the first deep color cell, or replaces at least one of the bright color cells BC included in the positioning symbol P3 with the second light color cell having a color different from the first light color cell, and gives a design different from the first positioning symbol P1 and the second positioning symbol P2 to the third positioning symbol P3. In this way, the illustration of both eyes of the animal character is generated.

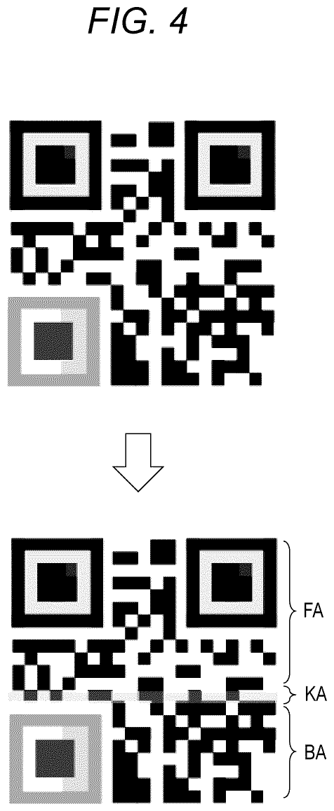

The face-body division unit 12 has a function of dividing the code area CA into the face area FA and the body area BA. Specifically, as illustrated in FIG. 4, the face-body division unit 12 divides the code area CA into the face area FA including the first positioning symbol P1 and the second positioning symbol P2, the body area BA including the third positioning symbol P3, and the boundary area KA between the face area FA and the body area BA, and replaces the bright color cell BC included in the boundary area KA with the predetermined background color cell.

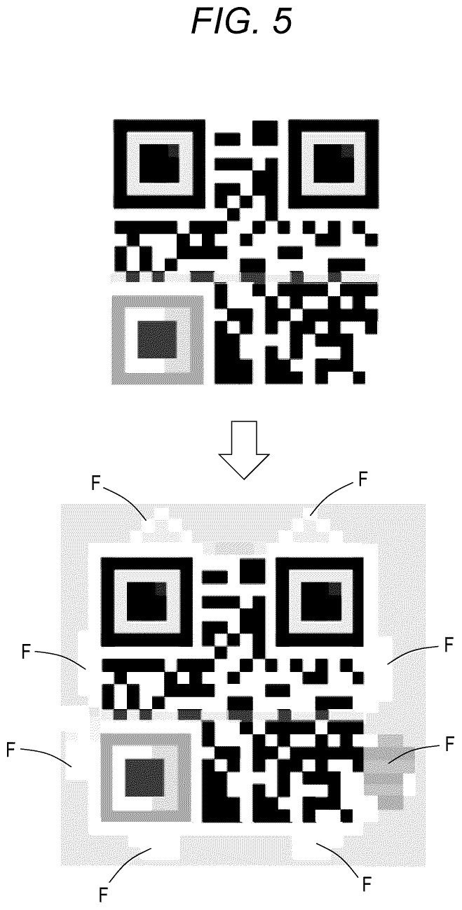

The frame addition unit 13 has a function of adding the frame F to the outside of the code area CA. Specifically, as illustrated in FIG. 5, the frame addition unit 13 adds the face part frame F representing a part of the face of the animal character around the face area FA or adds the body part frame F representing a part of the body around the body area BA outside of the code area CA. In the example of FIG. 5, a frame F of both ears and a frame F of both cheeks are added around the face area FA, and a frame F of both arms and a frame F of both legs are added around the body area BA.

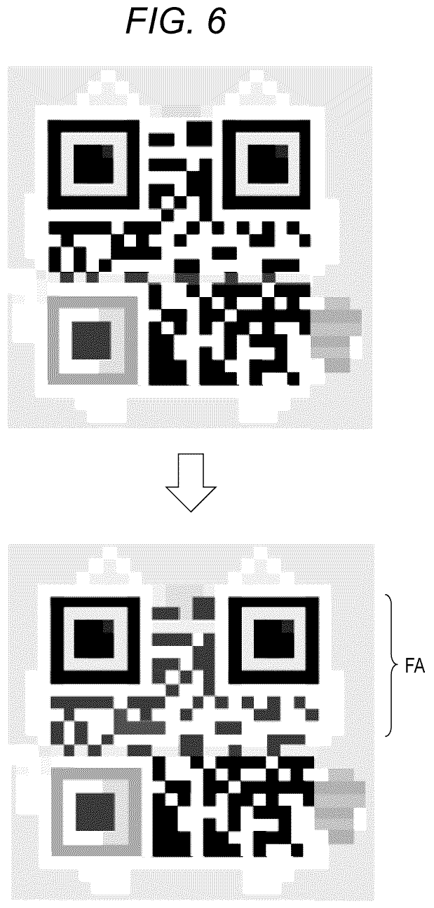

The face generation unit 14 has a function of generating the face area FA of the animal character. Specifically, as illustrated in FIG. 6, in the face area FA, the face generation unit 14 replaces at least one of the plurality of dark color cells DC included in the data area DA with the third deep color cell having a color different from the first deep color cell and the second deep color cell, or replaces at least one of the plurality of bright color cells BC included in the data area DA with the third light color cell having a color different from the first light color cell and the second light color cell. Similar processes can be performed in the body area BA (see FIG. 10).

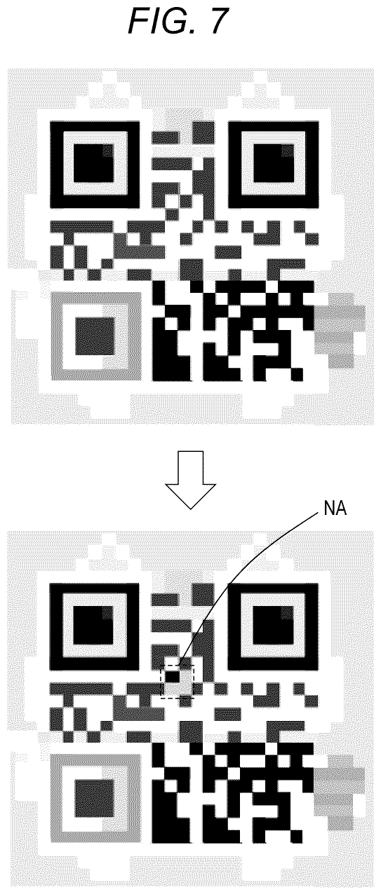

The nose generation unit 15 has a function of generating the nose area NA of the animal character. Specifically, as illustrated in FIG. 7, in the face area FA, the nose generation unit 15 replaces one or the plurality of dark color cells DC included in the nose area NA set between the first positioning symbol P1 and the second positioning symbol P2 in the horizontal direction and below the first positioning symbol P1 and the second positioning symbol P2 in the vertical direction with the fourth deep color cell having a color different from the first deep color cell, the second deep color cell, and the third deep color cell.

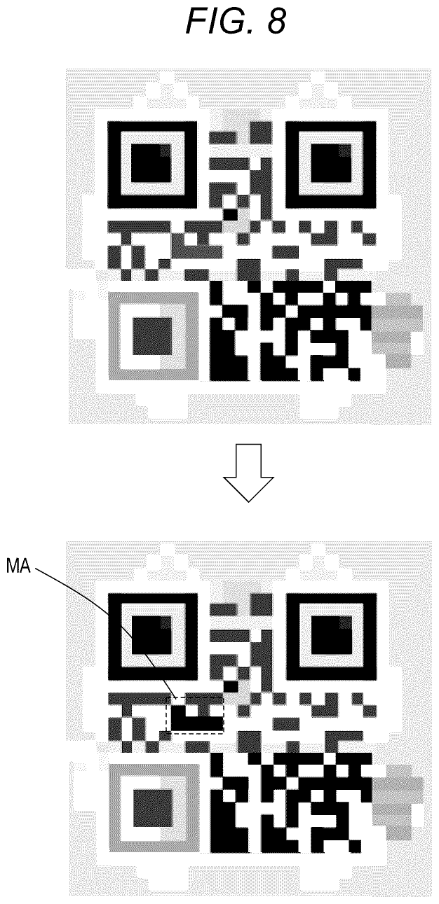

The mouth generation unit 16 has a function of generating the mouth area MA of the animal character. Specifically, as illustrated in FIG. 8, in the face area FA, the mouth generation unit 16 replaces one or the plurality of dark color cells DC included in the mouth area MA set further below the nose area NA set below the first positioning symbol P1 and the second positioning symbol P2 in the vertical direction with the fourth deep color cell having a color different from the first deep color cell, the second deep color cell, and the third deep color cell.

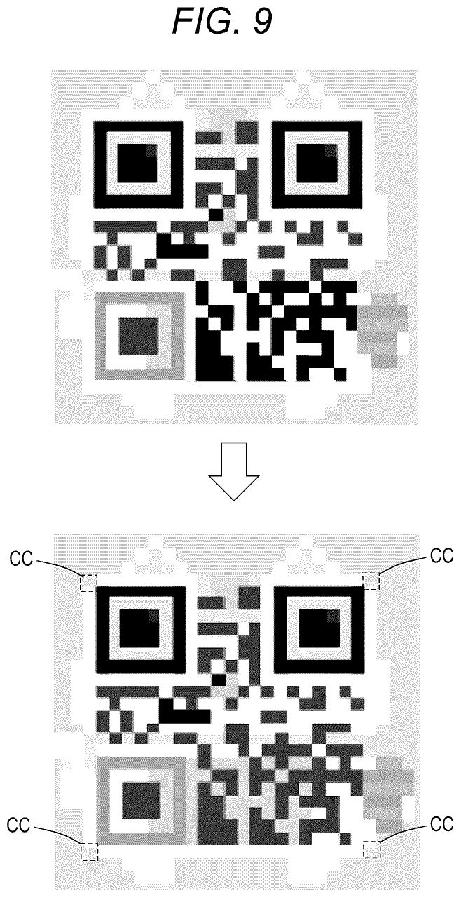

The corner rounding-off unit 17 has a function of rounding off corners of four vertexes of the code area CA. Specifically, as illustrated in FIG. 9, the corner rounding-off unit 17 replaces the cells CC arranged at the four vertexes of the code area CA with the predetermined background color cell. In this way, the two-dimensional code illustration I of the animal character is generated using the two-dimensional code C.

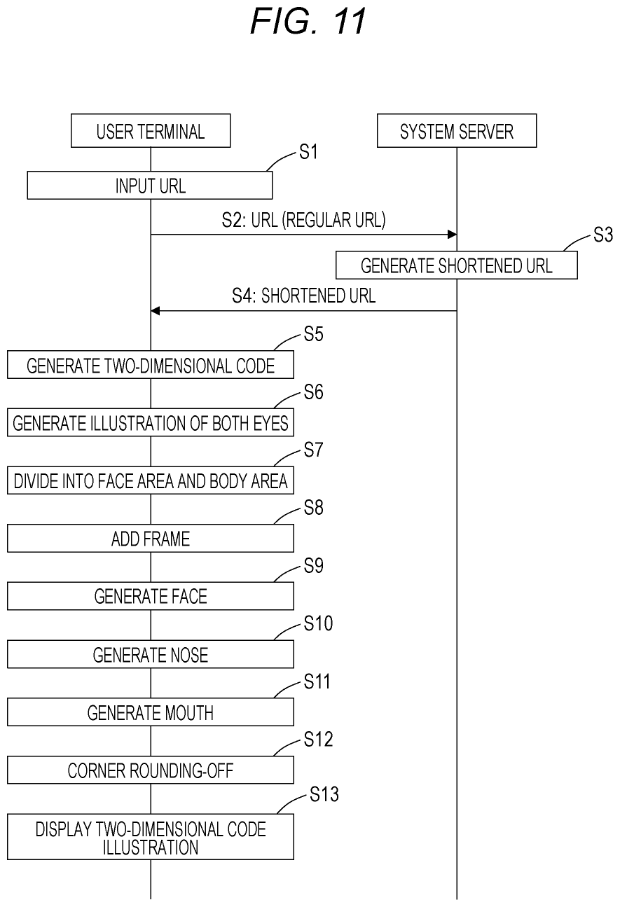

An operation of the two-dimensional code illustration generation system 1 that has the foregoing configuration will be described with reference to the sequence diagram of FIG. 11.

As illustrated in FIG. 11, when the two-dimensional code illustration I is generated using the two-dimensional code illustration generation system 1 according to the present embodiment, a URL (regular URL) of a store, a commercial facility, or the like is first input to the user terminal 2 (S1). The URL (regular URL) input by the user terminal 2 is transmitted to the system server 4 (S2), and the system server 4 generates a shortened URL having an amount of data less than the regular URL and a hash value (S3). Then, the shortened URL and the hash value are transmitted from the system server 4 to the user terminal 2 (S4).

As illustrated in FIG. 2, the user terminal 2 generates the two-dimensional code C in which the shortened URL and the hash value are encoded in the data area DA (S5).

Subsequently, the user terminal 2 generates an illustration of both eyes of an animal character using the positioning symbols P1 to P3 of the two-dimensional code C, as illustrated in FIG. 3, (S6) and divides the code area CA into the face area FA, the body area BA, and a boundary area KA as illustrated in FIG. 4 (S7). Then, as illustrated in FIG. 5, the frame F is added to the outside of the code area CA (S8).

Subsequently, the user terminal 2 generates the face area FA of the animal character, as illustrated in FIG. 6 (S9), generates the nose area NA of the animal character, as illustrated in FIG. 7 (S10), and generates the mouth area MA of the animal character, as illustrated in FIG. 8 (S11). Then, as illustrated in FIG. 9, the corners of the four vertexes of the code area CA are rounded off (S12). The two-dimensional code illustration I generated in this manner is displayed on the screen of the user terminal 2 (S13).

The two-dimensional code illustration generation system 1 according to the present embodiment generates an illustration of both eyes of an animal character using the positioning symbols P1 to P3 of the two-dimensional code C, further divides the two-dimensional code C into the face area FA and the body area BA, and adds the face part frame F to the face area FA or adds the body part frame F to the body area BA. Therefore, it is possible to generate an illustration of an animal character integrated with the two-dimensional code C (the visually recognized two-dimensional code C integrated with the illustration of the animal character). In this case, the dark color cell DC included in the two-dimensional code C is replaced with a deep color cell (the first deep color cell or the second deep color cell), and the bright color cell BC included in the two-dimensional code C is replaced with a light color cell (the first light color cell or the second light color cell). Therefore, data encoded in the two-dimensional code C can be read even from the generated illustration.

In the present embodiment, the bright color cell BC included in the boundary area KA between the face area FA and the body area BA is replaced with the background color cell. Therefore, the face area FA and the body area BA can be visually recognized separately in the illustration of the animal character integrated with the two-dimensional code C.

In the present embodiment, in the face area FA, the nose area NA is set at a position between both eyes (the first positioning symbol P1 and the second positioning symbol P2) in the horizontal direction and below both eyes (the first positioning symbol P1 and the second positioning symbol P2) in the vertical direction, and the dark color cell DC included in the nose area NA is replaced with a deep color cell (fourth deep color cell) having a color different from the other deep color cells (first to third deep color cells). Therefore, the face area FA (both eyes and the nose) can be visually recognized in the illustration of the animal character integrated with the two-dimensional code C.

In the present embodiment, in the face area FA, the mouth area MA is set between both eyes (the first positioning symbol P1 and the second positioning symbol P2) in the horizontal direction and further below the nose area NA set below both eyes (the first positioning symbol P1 and the second positioning symbol P2) in the vertical direction, and the dark color cell DC included in the mouth area MA is replaced with a deep color cell (fourth deep color cell) having a color different from the other deep color cells (the first to third deep color cells). Therefore, the face area FA (both eyes and the mouth) can be visually recognized in the illustration of the animal character integrated with the two-dimensional code C.

In the present embodiment, the cells arranged at the four vertexes of the code area CA of the two-dimensional code C are replaced with the background color cell. Therefore, the contour of the illustration of the animal character integrated with the two-dimensional code C can be rounded.

In the present embodiment, the amount of data encoded in data area DA can be reduced by using a shortened URL of which an amount of data is less than an amount of data of the regular URL (the notation of the URL is short).

When the shortened URL is not used, the amount of data of the regular URL is large (the notation of the URL is long), and the amount of data encoded in the data area DA is large, a proportion (area proportion) of the data area DA to the code area CA increases, and the sizes of the positioning symbols P1 to P3 relatively decrease. As a result, the size of both eyes of the animal character becomes small and the interval becomes wide, and it becomes difficult to recognize the animal character, or it becomes difficult to express the animal character cutely.

Even when the amount of data of the regular URL is large, the amount of data encoded in the data area DA can be reduced by using the shortened URL, and the sizes of the positioning symbols P1 to P3 can be maintained. As a result, the size of the both eyes of the animal character can be maintained at an appropriate size and an interval between the both eyes can be maintained at an appropriate distance, and the animal character can be easily recognized, or the animal character can be expressed cutely.

In the present embodiment, when the input data (for example, a URL of a store or the like) is included in the whitelist information, the two-dimensional code C is appropriately generated. The whitelist information (for example, a URL of a specific service member store, or the like) can be managed by, for example, a system operator.

In the present embodiment, when the input data (for example, a URL of a store or the like) is included in the blacklist information, the two-dimensional code C is prohibited from being generated. The blacklist information (for example, a URL of harmful site) can be managed by, for example, a system operator.

Although the embodiments of the present invention have been described above by way of example, the scope of the present invention is not limited thereto, and can be changed and modified according to the object within the scope described in the claims.

### INDUSTRIAL APPLICABILITY

As described above, the two-dimensional code illustration generation system according to the present invention has the advantage that an illustration of an animal character integrated with a two-dimensional code (a visually recognized two-dimensional code integrated with the illustration of the animal character) can be generated, and data encoded in the two-dimensional code can be read even from the generated illustration, and is useful as a system or the like generating an illustration of an animal character or the like using a two-dimensional code in which a URL of a store, a commercial facility, or the like is encoded.

### REFERENCE SIGNS LIST

1 Two-dimensional code illustration generation system
2 User terminal
3 Network
4 System server
Input unit
6 Output unit
7 Storage unit
8 Control unit
10 Two-dimensional code generation unit
11 Both-eye illustration generation unit
12 Face-body division unit
13 Frame addition unit
14 Face generation unit
15 Nose generation unit
16 Mouth generation unit
17 Corner rounding-off unit

1. A two-dimensional code illustration generation system generating an illustration of an animal character using a two-dimensional code,
wherein the two-dimensional code has a quadrangular code area having four corners,
wherein a positioning symbol is arranged at each of three corners among the four corners of the code area,
wherein the positioning symbol has a rectangular dark color pattern including a plurality of dark color cells arranged at a center part of the positioning symbol, a rectangular frame-shaped bright color pattern including a plurality of bright color cells arranged around the dark color pattern, and a rectangular frame-shaped dark color pattern including a plurality of dark color cells arranged around the bright color pattern,
wherein a data area where predetermined data is encoded using a plurality of bright color cells and a plurality of dark color cells is provided in a part inside the four corners of the code area, and
wherein the system comprises:
an input unit to which the predetermined data is input;
a two-dimensional code generation unit configured to generate the two-dimensional code in which the predetermined data is encoded in the data area based on the input predetermined data;
a both-eye illustration generation unit configured to generate an illustration of both eyes of the animal character by replacing at least one of dark color cells included in the positioning symbol with a first deep color cell or replacing at least one of bright color cells included in the positioning symbol with a first light color cell for each of adjacent first and second positioning symbols among three positioning symbols included in the generated two-dimensional code, giving a design identical to the first positioning symbol and the second positioning symbol, further replacing at least one of dark color cells included in the positioning symbol with a second deep color cell having a color different from the first deep color cell or replacing at least one of bright color cells included in the positioning symbol with a second light color cell having a color different from the first light color cell for a remaining third positioning symbol among the three positioning symbols, and giving a design different from the first positioning symbol and the second positioning symbol to the third positioning symbol;
a face-body division unit configured to divide the code area into a face area including the first positioning symbol and the second positioning symbol and a body area including the third positioning symbol;
a frame addition unit configured to add a face part frame representing a part of a face of the animal character around the face area or add a body part frame representing a part of the body around the body area outside of the code area; and
an output unit configured to generate an illustration of both eyes of the animal character, divide the illustration into the face area and the body area, and output the two-dimensional code to which the face part frame or the body part frame is added.

2. The two-dimensional code illustration generation system according to claim 1, wherein the face-body division unit divides the code area into a face area including the first positioning symbol and the second positioning symbol, a body area including the third positioning symbol, and a boundary area between the face area and the body area, and replaces a bright color cell included in the boundary area with a predetermined background color cell.

3. The two-dimensional code illustration generation system according to claim 1, further comprising:
a face generation unit configured to replace, in the face area, at least one of a plurality of dark color cells included in the data area with a third deep color cell having a color different from the first deep color cell and the second deep color cell, or replace at least one of a plurality of bright color cells included in the data area with a third light color cell having a color different from the first light color cell and the second light color cell; and
a nose generation unit configured to replace, in the face area, one dark color cell or a plurality of dark color cells included in a nose area set between the first positioning symbol and the second positioning symbol in a horizontal direction and below the first positioning symbol and the second positioning symbol in a vertical direction with a fourth deep color cell having a different color from the first deep color cell, the second deep color cell, and the third deep color cell.

4. The two-dimensional code illustration generation system according to claim 1, further comprising:
a face generation unit configured to replace, in the face area, at least one of a plurality of dark color cells included in the data area with a third deep color cell having a color different from the first deep color cell and the second deep color cell, or replace at least one of a plurality of bright color cells included in the data area with a third light color cell having a color different from the first light color cell and the second light color cell; and
a mouth generation unit configured to replace, in the face area, one dark color cell or a plurality of dark color cells included in a mouth area set further below a nose area set below the first positioning symbol and the second positioning symbol in a vertical direction with a fourth deep color cell having a color different from the first deep color cell, the second deep color cell, and the third deep color cell.

5. The two-dimensional code illustration generation system according to claim 1, further comprising a corner rounding-off unit configured to replace cells arranged at four vertexes of the code area with a predetermined background color cell.

6. The two-dimensional code illustration generation system according to claim 1,
wherein the predetermined data includes a shortened URL of which an amount of data is less than an amount of data of a regular URL and a hash value corresponding to the regular URL, and
wherein the regular URL is acquirable by using the shortened URL and the hash value.

7. The two-dimensional code illustration generation system according to claim 1, further comprising:
a whitelist storage unit configured to store data allowed to be encoded in the data area as whitelist information in advance,
wherein, when the input predetermined data is included in the whitelist information, the two-dimensional code generation unit generates the two-dimensional code in which the predetermined data is encoded in the data area.

8. The two-dimensional code illustration generation system according to claim 1, further comprising:
a blacklist storage unit configured to store data prohibited from being encoded in the data area as blacklist information in advance,
wherein, when the input predetermined data is included in the blacklist information, the two-dimensional code generation unit does not generate the two-dimensional code in which the predetermined data is encoded in the data area.

9. A method executed in a two-dimensional code illustration generation system that generates an illustration of an animal character using a two-dimensional code,
wherein the two-dimensional code has a quadrangular code area having four corners,
wherein a positioning symbol is arranged at each of three corners among the four corners of the code area,
wherein the positioning symbol has a rectangular dark color pattern including a plurality of dark color cells arranged at a center part of the positioning symbol, a rectangular frame-shaped bright color pattern including a plurality of bright color cells arranged around the dark color pattern, and a rectangular frame-shaped dark color pattern including a plurality of dark color cells arranged around the bright color pattern,
wherein a data area where predetermined data is encoded using a plurality of bright color cells and a plurality of dark color cells is provided in a part inside the four corners of the code area, and
wherein the method comprises:
a step of inputting the predetermined data;
a step of generating the two-dimensional code in which the predetermined data is encoded in the data area based on the input predetermined data;
a step of generating an illustration of both eyes of the animal character by replacing at least one of dark color cells included in the positioning symbol with a first deep color cell or replacing at least one of bright color cells included in the positioning symbol with a first light color cell for each of adjacent first and second positioning symbols among three positioning symbols included in the generated two-dimensional code, giving a design identical to the first positioning symbol and the second positioning symbol, further replacing at least one of dark color cells included in the positioning symbol with a second deep color cell having a color different from the first deep color cell or replacing at least one of bright color cells included in the positioning symbol with a second light color cell having a color different from the first light color cell for a remaining third positioning symbol among the three positioning symbols, and giving a design different from the first positioning symbol and the second positioning symbol to the third positioning symbol;
a step of dividing the code area into a face area including the first positioning symbol and the second positioning symbol and a body area including the third positioning symbol;
a step of adding a face part frame representing a part of a face of the animal character around the face area or adding a body part frame representing a part of the body around the body area outside of the code area; and
a step of generating an illustration of both eyes of the animal character, dividing the illustration into the face area and the body area, and outputting the two-dimensional code to which the face part frame or the body part frame is added.

10. A program executed by a computer of a two-dimensional code illustration generation system that generates an illustration of an animal character using a two-dimensional code,
wherein the two-dimensional code has a quadrangular code area having four corners,
wherein a positioning symbol is arranged at each of three corners among the four corners of the code area,
wherein the positioning symbol has a rectangular dark color pattern including a plurality of dark color cells arranged at a center part of the positioning symbol, a rectangular frame-shaped bright color pattern including a plurality of bright color cells arranged around the dark color pattern, and a rectangular frame-shaped dark color pattern including a plurality of dark color cells arranged around the bright color pattern,
wherein a data area where predetermined data is encoded using a plurality of bright color cells and a plurality of dark color cells is provided in a part inside the four corners of the code area, and
wherein the program causes the computer to perform:
a process of inputting the predetermined data;
a process of generating the two-dimensional code in which the predetermined data is encoded in the data area based on the input predetermined data;
a process of generating an illustration of both eyes of the animal character by replacing at least one of dark color cells included in the positioning symbol with a first deep color cell or replacing at least one of bright color cells included in the positioning symbol with a first light color cell for each of adjacent first and second positioning symbols among three positioning symbols included in the generated two-dimensional code, giving a design identical to the first positioning symbol and the second positioning symbol, further replacing at least one of dark color cells included in the positioning symbol with a second deep color cell having a color different from the first deep color cell or replacing at least one of bright color cells included in the positioning symbol with a second light color cell having a color different from the first light color cell for a remaining third positioning symbol among the three positioning symbols, and giving a design different from the first positioning symbol and the second positioning symbol to the third positioning symbol;
a process of dividing the code area into a face area including the first positioning symbol and the second positioning symbol and a body area including the third positioning symbol;
a process of adding a face part frame representing a part of a face of the animal character around the face area or adding a body part frame representing a part of the body around the body area outside of the code area; and
a process of generating an illustration of both eyes of the animal character, dividing the illustration into the face area and the body area, and outputting the two-dimensional code to which the face part frame or the body part frame is added.
